(19) United States
(12) Patent Application Publication
(10) Pub. No.: US 2024/0058942 A1
(43) Pub. Date: Feb. 22, 2024

(54) SAWHORSE

(71) Applicant: Perfect Site LLC, Las Vegas, NV (US)

(72) Inventor: Jared W. Hanlon, Las Vegas, NV (US)

(21) Appl. No.: 18/497,692

(22) Filed: Oct. 30, 2023

Related U.S. Application Data
(63) Continuation-in-part of application No. 18/076,252, filed on Dec. 6, 2022.
(60) Provisional application No. 63/421,906, filed on Nov. 2, 2022.
(60) Provisional application No. 62/286,980, filed on Jan. 26, 2016.
(60) Provisional application No. 63/421,906, filed on Nov. 2, 2022.

(51) Int. Cl. B25H 1/06

(52) U.S. Cl. CPC B25H 1/06

(57) ABSTRACT

An end support is for a sawhorse. The sawhorse includes a body comprising a plurality of rails, a first pair of legs connected to the body, and a second pair of legs connected to the body. The end support includes a top side, a rear side, a pair of receiving portions, and a pair of opposing and spaced apart protrusions. The receiving portions each extend between the top side and the rear side. Each of the receiving portions is configured to receive and be coupled to at least one of the plurality of rails. Each of the protrusions extends outwardly from the rear side and is configured to nest between opposing legs of a leg bracket of another sawhorse.

### RELATED APPLICATION DATA

This application claims priority to U.S. Provisional Application Ser. No. 63/421,906, filed Nov. 2, 2022, and is a continuation-in-part of U.S. application Ser. No. 18/076,252, filed Dec. 6, 2022, which claims priority to U.S. Provisional Application Ser. No. 62/286,980, filed Dec. 7, 2021, and U.S. Provisional Application Ser. No. 63/421,906, filed Nov. 3, 2022, and incorporates by reference each of said applications as if set forth fully herein.

### FIELD OF THE INVENTION

The present invention relates to workpiece supports such as stands and sawhorses.

### BACKGROUND OF THE INVENTION

Sawhorses are often used to support workpieces, tools and the like. However, many sawhorse designs occupy a lot of space, particularly when being shipped and/or stored. Further, many existing sawhorses are heavy, making them expensive to transport and difficult to move.

Accordingly, it is with respect to these and other considerations that the disclosure made herein is presented.

### SUMMARY OF THE INVENTION

One aspect of the invention is a workpiece and/or tool support, such as a sawhorse.

In one embodiment, the sawhorse has a body. The body includes a first end support, a second end support, and a plurality of rails extending between the first and second end supports. The sawhorse also includes a first pair of hinged legs pivotally connected to the body, and a second pair of hinged legs pivotally connected to the body. The first pair of hinged legs and the second pair of hinged legs are each configured to move from a stowed position to an extended position, with respect to the body.

In another embodiment, the sawhorse has a body including a first end support, a second end support, a central support disposed between the first and second end supports, and a plurality of rails. The sawhorse also includes a first pair of legs pivotally connected to the body, and a second pair of legs pivotally connected to the body. The plurality of rails includes a first plurality of rails extending between the first end support and the central support, and a second plurality of rails extending between the second end support and the central support.

Further objects, features, and advantages of the present invention over the prior art will become apparent from the detailed description of the drawings which follows, when considered with the attached figures.

### DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIGS. 1, 2, 3, and 4 are front isometric, top plan, front, and side views of a sawhorse, respectively, in accordance with one non-limiting embodiment of the disclosed concept.

FIG. 5 is a side view of the sawhorse of FIG. 4, and is shown with the legs in a collapsed position.

FIG. 6 is another side view of the sawhorse of FIG. 4.

FIG. 7 is an exploded isometric view of the sawhorse of FIG. 6.

FIG. 8 is an exploded isometric view of a portion of the sawhorse of FIG. 7.

FIGS. 9 and 10 are different exploded isometric views of different portions of the sawhorse of FIG. 7.

FIG. 11 is a rear isometric view of the sawhorse of FIG. 7, shown with the pairs of hinged legs in an extended position.

FIG. 12 shows the sawhorse of FIG. 11, shown with the pairs of hinged legs between the extended position and a stowed position.

FIG. 13 shows the sawhorse of FIG. 12, shown with one of the pairs of hinged legs in a stowed position.

FIG. 14 shows the sawhorse of FIG. 13, shown with both of the pairs of hinged legs in a stowed position.

FIG. 15 shows a portion of the sawhorse of FIG. 1.

FIG. 16 shows an exploded isometric view of components of the portion of FIG. 15.

FIG. 17 is a front isometric view of another sawhorse, in accordance with another non-limiting embodiment of the disclosed concept.

FIG. 18 is an enlarged view of a portion of the sawhorse of FIG. 17.

FIG. 19 is an exploded isometric view of components of the portion of FIG. 18.

FIGS. 20-23 show isometric, top, front, and a portion of side views, respectively, of another sawhorse, in accordance with another non-limiting embodiment of the disclosed concept.

FIGS. 24-26 show partially cutaway rear isometric, exploded isometric, and a portion of an exploded isometric view, respectively, of the sawhorse of FIGS. 20-23.

FIGS. 27-30 show front isometric, front, right side, and rear isometric views, respectively, of an end support for the sawhorse of FIGS. 20-26.

FIGS. 31-34 show front isometric, top, front, and cutaway side views, respectively, of another sawhorse, in accordance with another non-limiting embodiment of the disclosed concept.

FIGS. 35-37 show partially cutaway rear isometric, cutaway exploded isometric, and cutaway isometric with hidden lines views, respectively, of the sawhorse of FIGS. 31-34.

FIGS. 38-41 show front isometric, front, right side, and rear isometric views, respectively, of an end support for the sawhorse of FIGS. 31-37.

FIGS. 42-44 show front, cutaway enlarged, and portion of an isometric views, respectively, of a packaging kit including two of the sawhorses of FIGS. 31-37, in accordance with another non-limiting embodiment of the disclosed concept.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

One embodiment of the invention is support for workpieces, tools and the like. In one embodiment, the support may be referred to as a sawhorse.

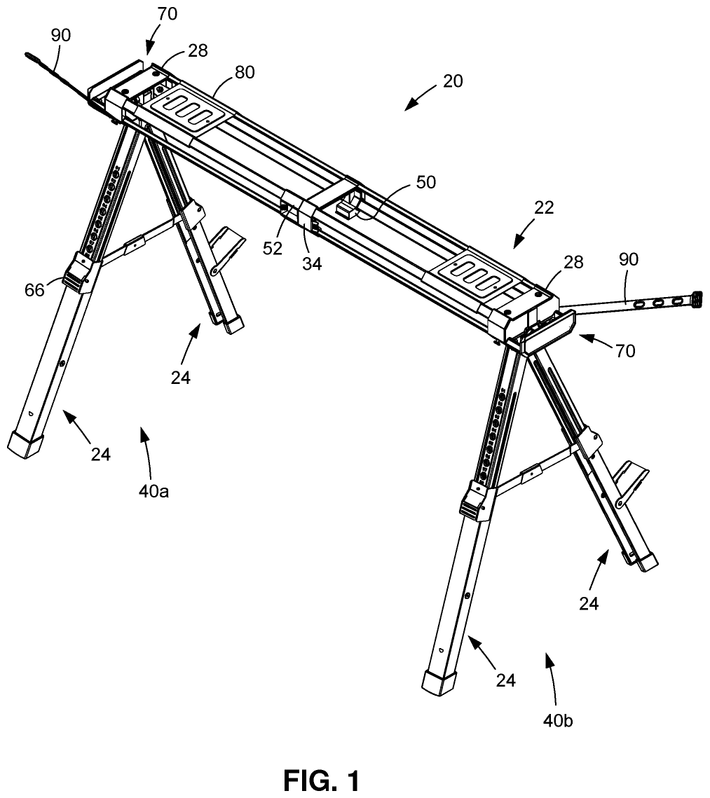

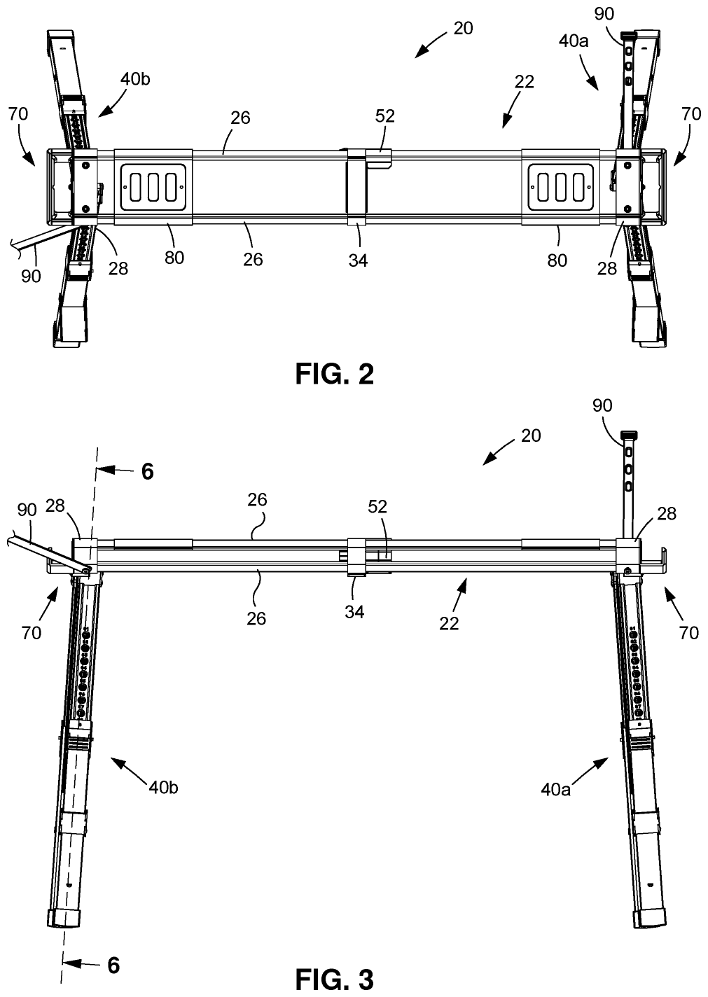

One embodiment of the invention will be described with reference to FIGS. 1-14. In general, in one embodiment as shown in FIGS. 1 and 2, a sawhorse 20 includes a body 22 which may be supposed by pairs of legs 40a,40b which may be hingedly mounted to the body 22. The body 22 may comprise a plurality of spaced, elongate rails 26 which extend between end supports 28. Additionally, the sawhorse 20 may include a number of workpiece securing members, such as straps 90 coupled to the end supports 28 for securing workpieces to the sawhorse 20.

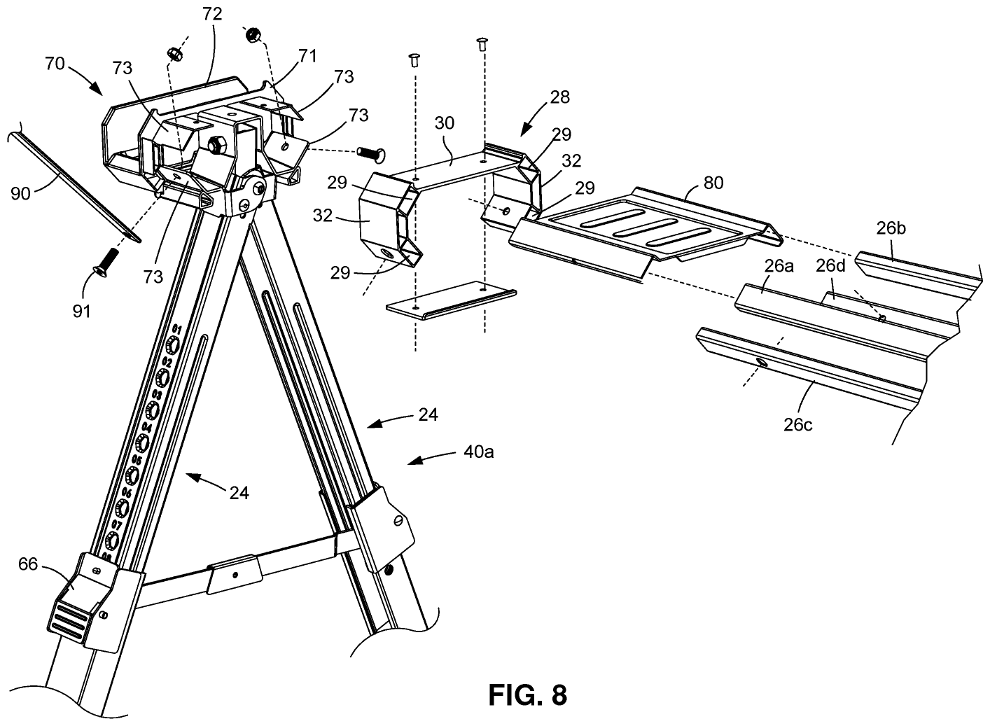

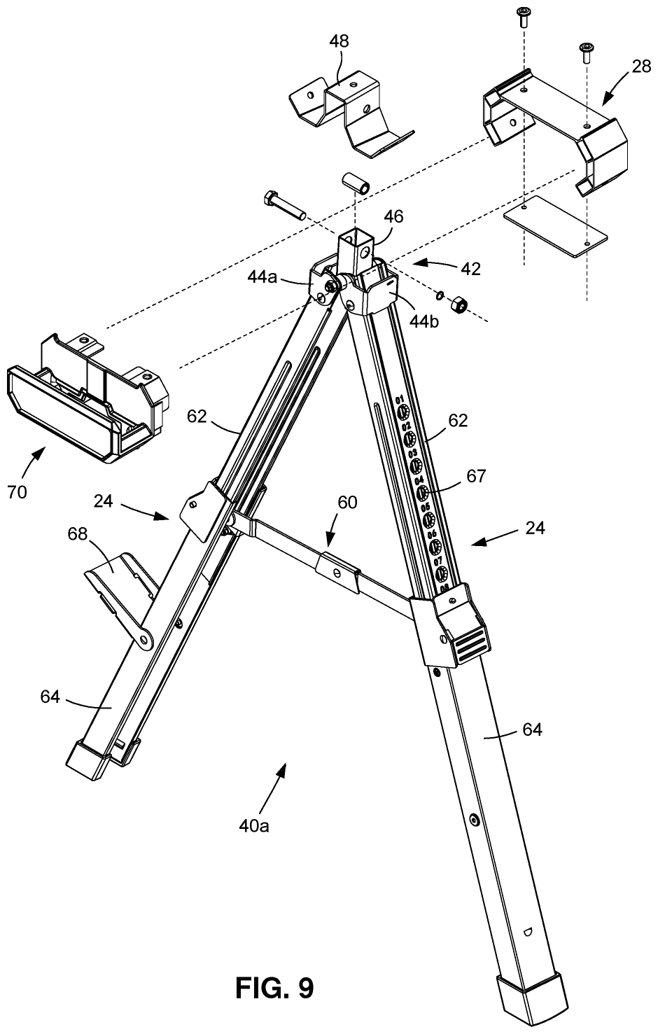

The end supports 28 may, as shown in FIGS. 1-6, but as best illustrated in FIGS. 8 and 9, comprise generally C-shaped bodies, such as formed from extruded aluminum. The end supports 28 may define a central section 30 (which may be generally planar) and first and second rail mounts 32 at opposing ends of the central section. The rail mounts 32 may define one or more openings 29, or apertures, such as for receiving a portion of a rail 26 therein.

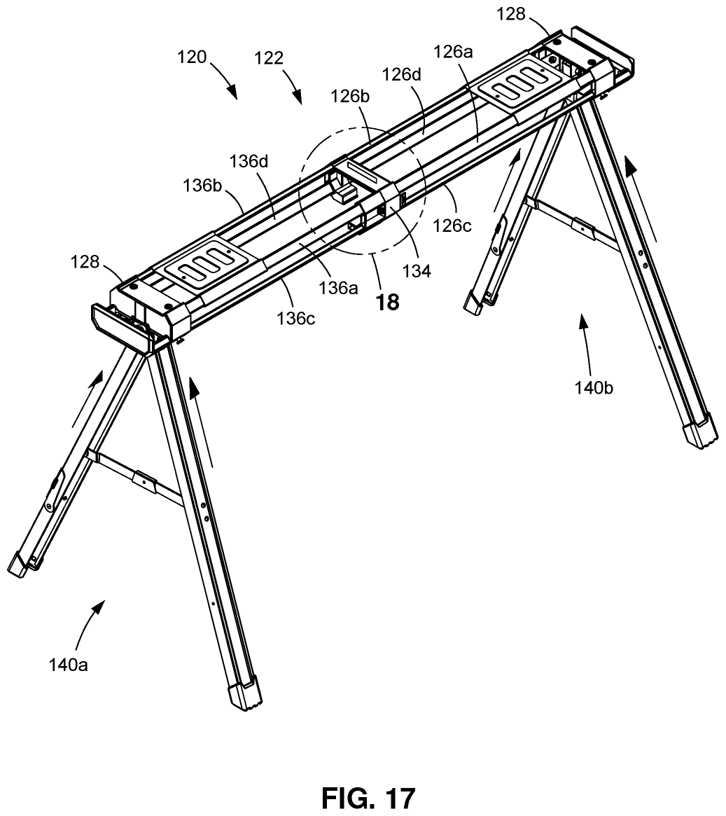

In one embodiment, the rails 26 extend between the end supports 28. In one embodiment, the rails 26 may directly extend between a pair of end supports 28 (e.g. where the ends of the rails 26 terminate at the end supports 28; although in other embodiments, the one or more of the rails might extend beyond the end support(s) 28). In other embodiments, a first set of rails 26 may extend between a first of the end supports and a central support 34 (or one or more intermediate supports), and one or more other sets of rails 26 may extend from the central support 34 to the second end support 28 (this allows, for example, for the sawhorse 20 to be broken into components of smaller dimensions, such as for shipping). This is discussed below in association with FIGS. 17-19. The central support 34 may be similar to (e.g., structured the same as) the end supports 28, such as having a central section and a pair of rail mounts, and where the central support 34 includes an extruded aluminum member. Thus, the length of the body 22 may vary, such as depending upon the lengths of the rails 26 and/or the number of rails 26 which are utilized.

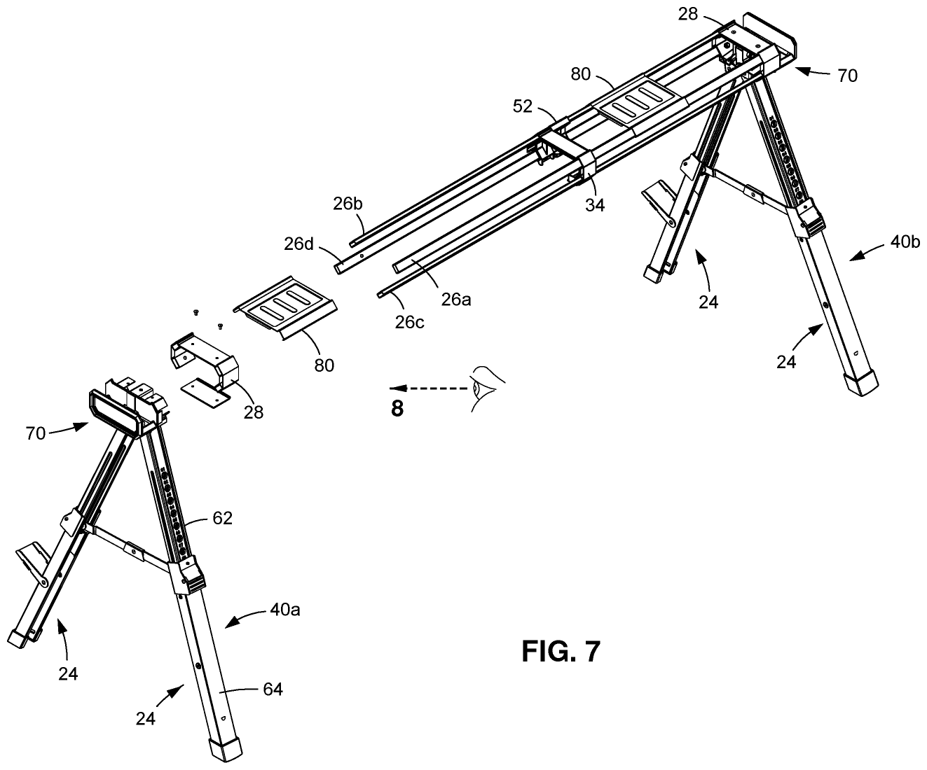

In one embodiment, the rails 26 comprise extruded members as well, such as tubular piping (so as to be lightweight). For example, the rails 26 may include generally square tubing of metal, fiberglass, etc. In one embodiment, the body 22 has first and second upper rails 26a,b and first and second lower rails 26c,d, such as illustrated in FIG. 7. The first and second upper rails 26a,b may be spaced apart to define a upper channel, and be generally coplanar with the top or central section 30 of the end supports 28. The first and second lower rails 26c,d may be located below the upper rails and may also be spaced apart from one another, such as to define a lower channel. The rails may generally define an interior space of the body 22 below a top of the body.

In one example, the lower rails 26c,26d and the upper rails 26a,26b extend between the first and second end supports 28 and define corresponding lower and upper channels. Additionally, it will be appreciated that each of the pair of lower rails 26c,26d and the pair of upper rails 26a,26b includes an end configured to be slid into a corresponding opening (e.g., openings 29 shown in FIG. 8) of a corresponding one of the first and second end supports 28. As such, the rails 26a, 26b, 26c, 26d extend through the openings 29 of each of the first and second end supports 28 in order to provide support to the first and second end supports 28. Accordingly, the rails 26 may be detachably connected to the end supports 28 and the central support 34. The ends might, in one example, then be fixed, such as with a fastener or the like. This allows the sawhorse 20 to be made from individual components of a small size which facilitates a small packing dimension for shipping and storage, but which allows the sawhorse 20 to be easily assembled for use (and, if desired, disassembled at a later time).

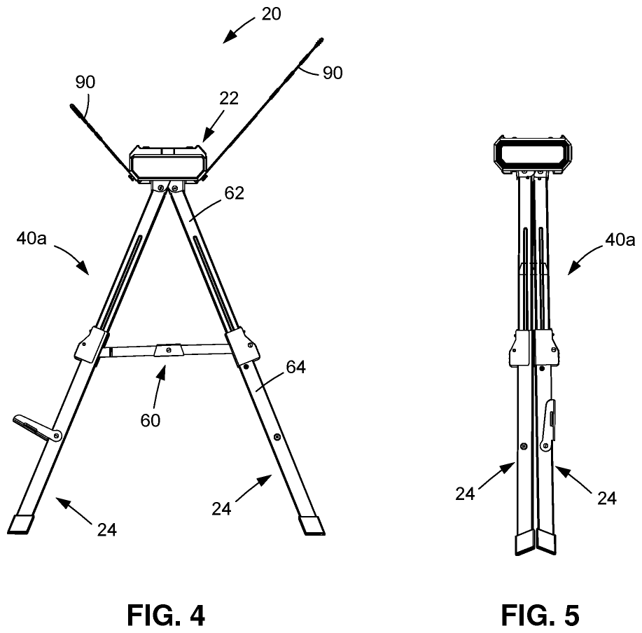

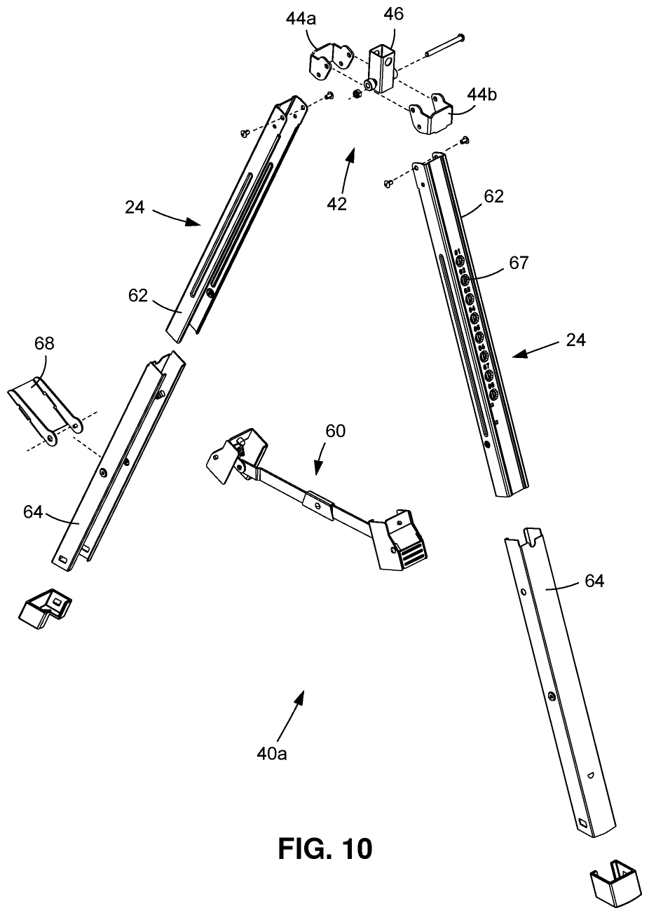

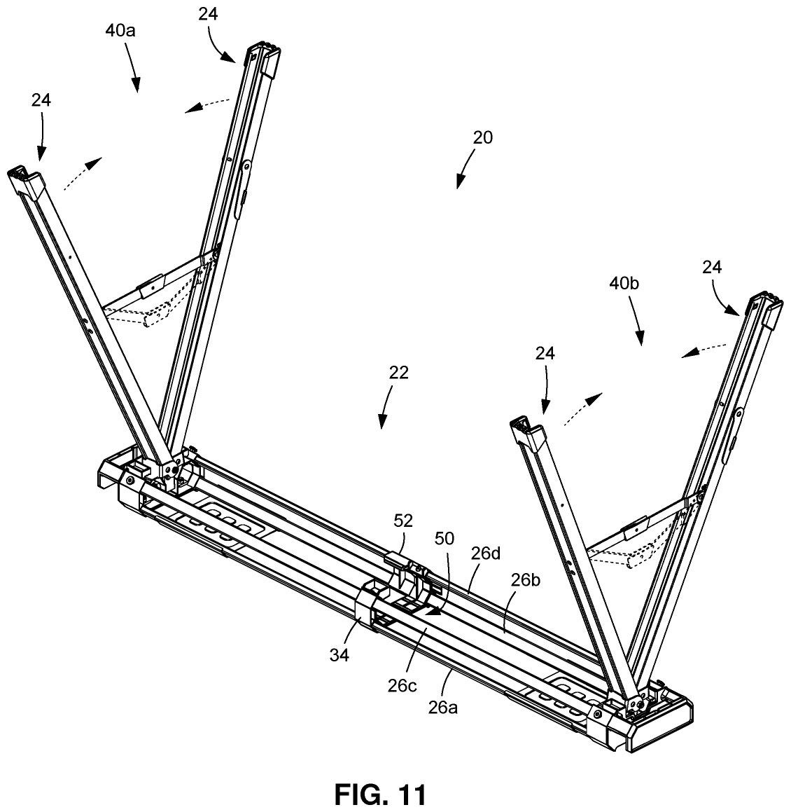

The body 22 of the sawhorse 20 is preferably supportable by the one or more legs 24. In one embodiment, the legs 24 comprise first and second pairs of legs 40a,b. As best illustrated in FIGS. 10 and 11, the pairs of legs 40a,b may comprise first and second legs 24 which are hingedly connected at a top end, such as by a hinge 42 (which may comprise first and second hinge members 44a,b which connect to the legs and then are rotatably connect to a hinge mount 46). This allows the first and second legs 24 of each pair of legs 40a,b to be moved between an expanded position (such as illustrated in FIG. 4) and a collapsed position (such as illustrated in FIG. 5).

Further, in a preferred embodiment, each pair of legs 40a,b may be moved from a stowed position (FIG. 14) to an extended position (FIG. 1), with respect to the body 22. In the stowed position (FIG. 14), the first and second legs 24 of each pairs of legs 40a,b is preferably moved to their collapsed position, and the pairs of legs 40a,b are then moved to a position in which the pairs of legs 40a,b extend generally parallel to the length of the body 22, along the bottom thereof. In the extended position, each pair of legs 40a,b extends outwardly from the body 22, such as generally perpendicular to the length thereof, such as illustrated in FIG. 3.

In one embodiment, this is accomplished by movably mounting each pair of legs 40a,b to the body 22. For example, as illustrated in FIG. 9, each pair of legs 40a,b is connected to a mounting bracket 48. In one embodiment, the hinge mount 46 of each pair of legs 40a,b is pivotally connected to one of the mounting brackets 48. The mounting bracket 48 is then connected to one of the end supports 28, such as with one or more fasteners. The mounting permits each pair of legs to pivot about a generally horizontal axis through the body 22.

In one embodiment, when the pairs of legs 40a,b are moved to their stowed position, the legs fit into the space between the rails 26 at each side of the body 22. The pairs of legs 40a,b may be maintained in the stowed position by one or more leg locks. The leg locks may comprise, for example, a first fixed leg lock 50 which is associated with the central support 34 (see FIG. 1) and a second sliding lock 52 (see FIGS. 1 and 2) which is mounted on one of the rails 26 and is movable therealong. The sliding lock 52 may be moved to a retracted position (away from the central support 34) and the pairs of legs 40a,b may be pivoted inwardly to their stowed position.

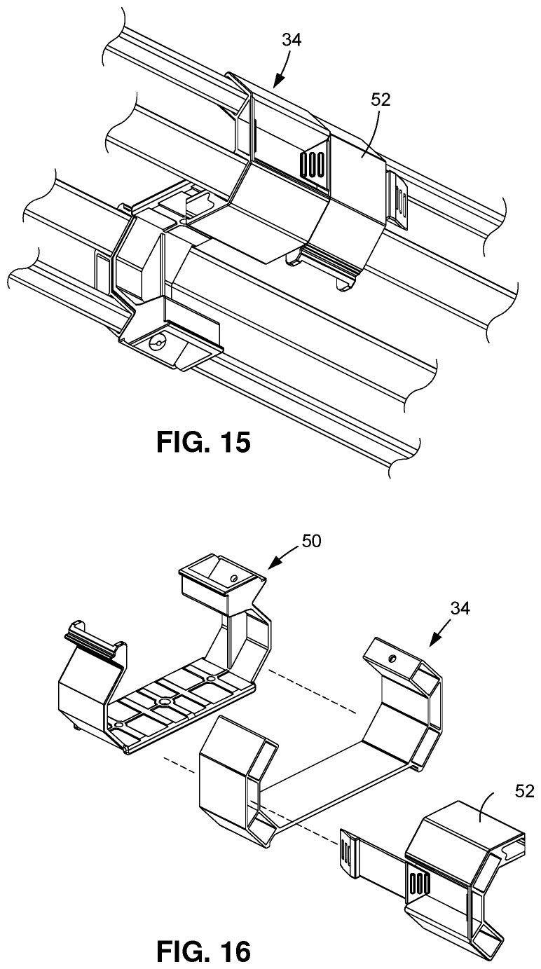

For example, a first of the pairs of legs 40a,b may be moved under the fixed leg lock 50 to capture it (and prevent that pair of legs 40a,b from moving outwardly away from the body 22). The second sliding leg lock 52 may then be slid along the rail 26 to engage the second pair of legs 40a,b, which at the same time keeps the first pair of legs 40a,b under the first leg lock 50. In particular, in one embodiment, the distance between the first and second leg locks 50,52 is smaller than the width of the pairs of legs 40a,b and 40c,d, such that once the sliding leg lock 52 is moved into place, neither pair of legs can move between the leg locks and away from the body 22. In one embodiment, as illustrated in FIG. 16, the sliding lock 52 may include an extending finger-engaging tab which can be slid through a portion of the central support 34 to maintain it in its locked position.

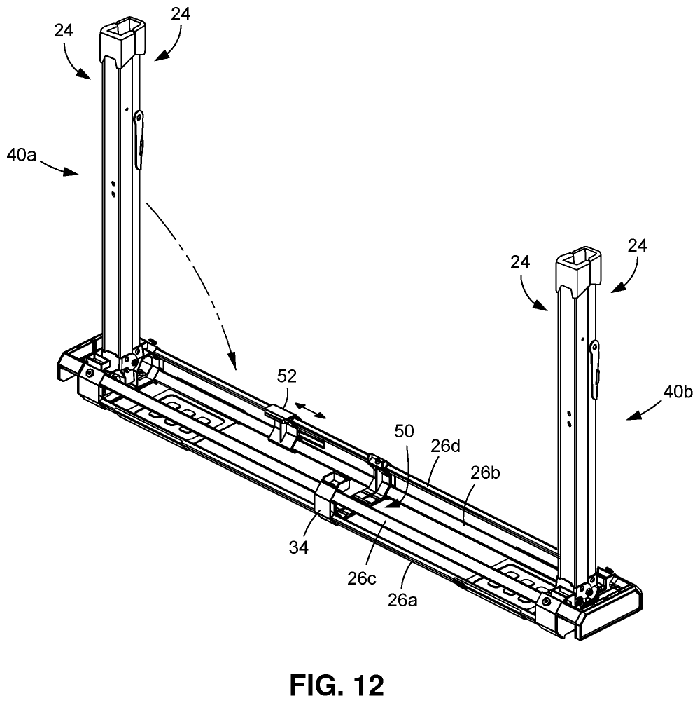

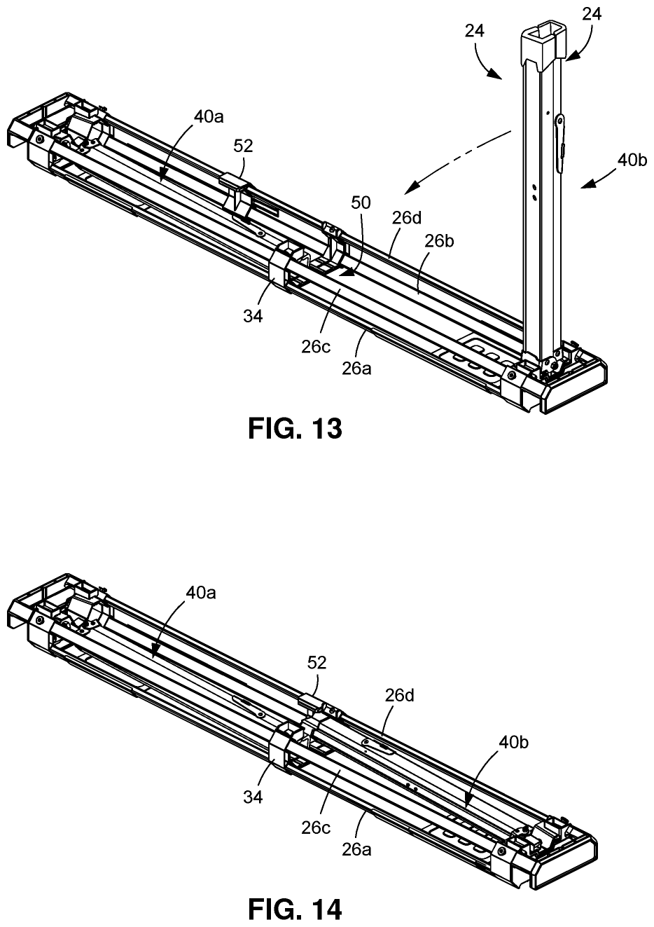

See, for example, FIGS. 11-13. As shown, the sliding leg lock 52 is configured to move from a first position (FIG. 11) to a second position (FIGS. 12 and 13). When the sliding leg lock 52 moves from the first position (FIG. 11) toward the second position (FIGS. 12 and 13), the sliding leg lock 52 moves away from the central support 34. Furthermore, it will be appreciated with reference to FIGS. 13 and 14, that the sliding leg lock 52 is configured to be slid along one of the rails 26 to engage the pair of hinged legs 40a, in order to keep the pair of hinged legs 40a under the fixed leg lock 50. Accordingly, it will be appreciated that the fixed and sliding leg locks 50,52 are configured to maintain the hinged legs 40a,40b in a stowed position (FIG. 14). Additionally, and continuing to refer to FIG. 14, in the stowed position, the first and second pairs of hinged legs 40a,40b are each located between the first and second rails 26a,26b, and also between the third and fourth rails 26c,26d. Moreover, in the stowed position (FIG. 14), the first and second pairs of hinged legs 40a,40b each extend generally parallel to a length of the body 22.

The pairs of legs 40a,b may have a variety of features. For example, as illustrated, at least one collapsible support 60 (such as comprising first and second struts which are pivotally connected between the legs) may extend between the first and second legs 24 of each pair of legs 40a,b, such as to prevent the first and second legs from moving to an over-expanded position under load. The first and second legs of each pair of legs 40a,b may also be extendable, such as to change the lengths thereof. In one embodiment, as illustrated in FIGS. 8-10, each leg may comprise a base portion 62 (mounted to the hinge 42) and an extendable portion 64 mounted to the base portion 62. The extendable portion 64 may include a selector 66 (such as a pivoting latch which may be biased to an engaged position and which can be manually moved out of engagement) for selectively engaging the base portion 62, such as at holes 67, slots, etc. of the base portion 62, for releasably maintaining the leg at a desired length. In other words, the selector 66 is configured to extend through each of the plurality of holes 67 in order to releasably maintain each leg 24 at a desired length.

One or more of the legs may also include other features, such as a rotating or pivoting mount 68. The mount 68 might be hingedly or rotatably mounted to the leg 24 so as to be movable between a retracted position in which it extends generally parallel to and along the leg, and an extended position in which it extends outwardly generally perpendicular thereof, thus forming a support (see FIG. 9). For example, a 2×4, second of pipe or other workpiece might be supported by mounts which are moved to their extended positions on one side of the sawhorse 20.

A foot may be located at the free end of each of the extendable portion 64 of each leg. The foot may comprise a protective cap or other member, such as which may be extendable or swivel, such as to provide stability to the sawhorse 20 when it is mounted on an uneven surface.

In one embodiment, as illustrated in FIG. 1, an end cap 70 may be located at each end of the body 22. The end caps 70 may comprise a body which connects to (or is formed as part of) the end support 28, such as by having portions which fit into the openings of the end support 28. The end caps 70 may extend outwardly from the end supports 28 in a direction opposite the rails 26.

In one embodiment, the end caps 70 comprise molded plastic or the like. The end caps 70 may include a flange portion 72, such as which is spaced from another portion of the end cap 70 so as to define a space, such as to create a cord wrap 72 or a workpiece support (such as a channel for accepting a portion of pipe, member or the like). The end caps 70 may include other features, such as a tray, handle, etc. In this regard, different end caps 70 might be provided and might be selectively connected to the end caps 28, such as depending upon the desired functionality thereof.

As shown in FIG. 8, the end cap 70 (e.g., and the other end cap 70 located at the other end of the body 22, not shown in FIG. 8) includes a body portion 71 and a plurality of protrusions 73 extending outwardly from the body portion 71. It will be appreciated that each of the protrusions 73 extends into a corresponding one of the openings 29 of the end support 28 in order to connect the end cap 70 to the end support 28. The end cap 70 and end support 28 at the other end of the body 22 (not shown in FIG. 8) are similarly structured. Of course, other means may be provided for interconnecting the end caps 70 to the end supports 28, such as fasteners, a configuration where protrusions extend from the end supports 28 into engagement with receiving portions of the end caps 70, etc.

In one embodiment, the body 22 of the sawhorse 20 is skeletal in nature (e.g. generally open in the space between the rails 26—both between the rails at opposing sides and between rails on each side). One or more trays 80 or other elements may be selectively located on or be connected to the rails 26 (such as the upper rails 26a,b), such as for defining work supporting surfaces, tool/work piece containing areas, etc. (the trays 80 might be generally planar, or might have depressions which extend down into the body 22 between the rails 26, etc.).

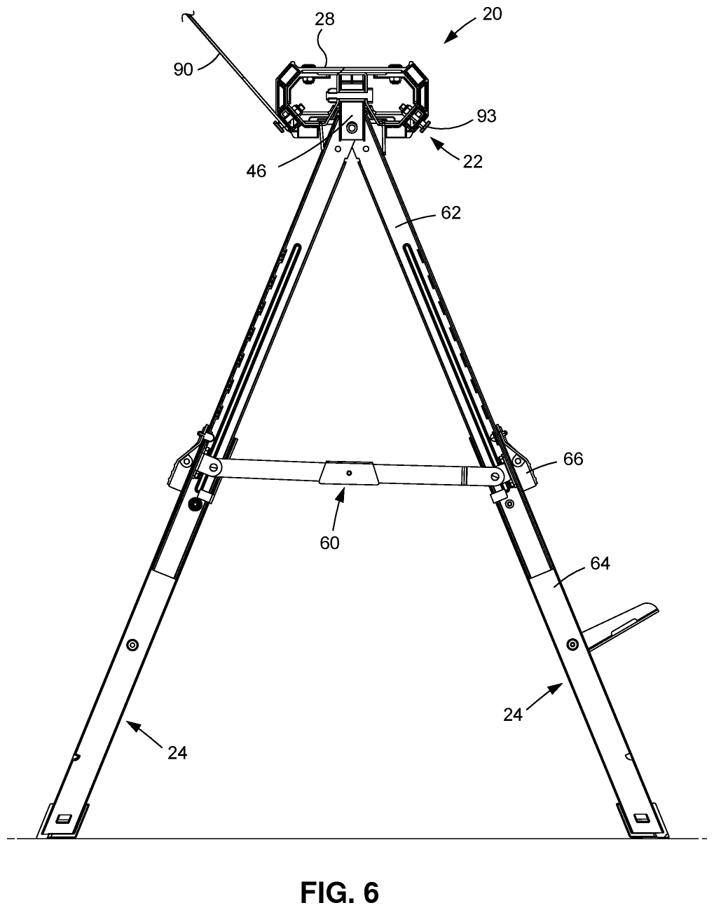

In one embodiment, the sawhorse 20 may include one or more workpiece securing members or elements F46. As one example, the sawhorse 20 may include one or more straps 90. The straps 90 may be associated with the end supports 28, such as for securing a workpiece at one or both ends of the sawhorse 20. The straps 90 may have a first end which is mounted or connected to the end support 28, such as via a fastener (see FIG. 8). The opposing end of each strap 90 might be configured to engage another strap, or the sawhorse 20. For example, as illustrated in FIG. 6, the strap 90 might be extended over the top of the end cap 28 and an associated workpiece thereon, with the free or opposing end of the strap 90 then connected to the end support 28, such as at the opposing side from the first end of the strap 90. In one embodiment, means may be provided for securing the strap 90, such as by one or more openings in the strap 90 which may accept a locking tab 93.

In one embodiment, more than one strap 90 may be provided, such as straps 90 at opposing sides of each end cap 28. Further the straps 90 might have other configurations, such as comprising an elongate element with associated hook and loop fastening material, such as which allows the free end of the strap to be extended over the end cap 28, through a slotted connector, and then looped back onto itself where sections of hook and loop material engage the secure the strap 90. In other embodiments, the straps 90 at opposing sides of the end cap 28 may be configured to be engaged to secure a workpiece, such as where the straps 90 at opposing sides are extended towards one another and are connected.

The sawhorse 20 has a number of advantages and may have other features and configurations.

First, the sawhorse 20 is generally modular, wherein it can be constructed from a number of small individual components into a large structure. The skeletal configuration of the sawhorse 20 and the use of lightweight elements such as extruded end and central supports and tubular rails aids in reducing the weight of the sawhorse 20 (for shipping and use, such as when being moved by a user) —such as compared to conventional sawhorses which have a large solid central body mounted between legs.

The body 22 could also include other intermediate supports, such as placed between the end supports and/or the end supports and a central support, such as for increasing the rigidity and strength of the body 22. In one embodiment, one or more of the rails may extend entirely through such a central or intermediate support (instead of having an end mounted thereto).

In some embodiments, the end and central supports and the rails are constructed from metal. However, plastic covers or the like may be placed over or around those components, such as to protect them (or those members might be coated, etc.).

The use of extruded end and central supports has a number of advantages, aside from weight. In one embodiment the use extruded members allows for single-piece construction with easy “slip to fit” assembly of the rails thereto, which simple connections with fasteners. This reduces the number of fasteners, welding steps, bending tools and overall manufacturing process, resulting in as much as 75% reduction in the number of steps to make the sawhorse 20 as compared to conventional designs.

In one embodiment the top rails 26 define an upper channel therebetween. This channel may be configured to hold a 2×4 to allow a saw to be used on it and not cut into the body.

In one embodiment, the sliding leg lock 52 is held in its locked position (thus locking the pairs of legs 40a,b in their stowed position) when the molded tine contacts the central support 34. There may be a protruding static tooth on the opposite side of the sliding leg lock 52 that acts as a secondary leg lock/bracket. The fixed tooth may hold the first pair of legs that is moved to the stowed position. After placing the second pair of legs into the body, the first pair of legs is pushed over and makes contact with the fixed tooth, preventing them from moving.

In one embodiment, the lower rails 26c,d may extend though the end supports 28 to provide a support such as a 2×4 (or other workpiece). The free ends of those rails 26c,d may then be capped, such as with a plastic molded body. The end of those rails might otherwise have an array of cleats applied to the end to help hold a 2×4 in place, including but not limited to sheet meatal bracket, cast zinc or aluminum parts and so on.

In one embodiment, when the pairs of legs 40a,b are stowed, they are located in the body 22 (e.g. between the upper rails 26a,b and the lower rails 26c,d) and the body 22 is generally planar and elongate. The sawhorse 20 then has a reduced dimension, such as for storage. Further, the sawhorse 20 is then easily stacked on another sawhorse, wherein the molded end cap 70 engages the sawhorse below it, allowing it to be stacked securely without the use of a clip system.

In one embodiment, the tray 80 may comprise a panel (such as a metal panel) may be applied to the top of the body 22 that is used for both storage/work surface as well as add some structural rigidity. The longer the unit the more panels may be applied.

In one embodiment, the overall length of the body 22 is made to fit on to a standard pallet, with an overall length being equal to or less than 40″ or 48″.

In one embodiment, the sawhorse 20 may be used to support workpieces, tools and the like. For example, miter saw mounting brackets might be connected to the rails 26, thus allowing the sawhorse 20 to be used as a miter saw stand.

The skeletal nature of the body 22 allows it to easily be gripped (such as by grabbing one of the rails 26) for movement.

In one embodiment, not all of the rails need to be attached to the end supports (such as only the lower rails). Further, in some embodiment, a number of rails other than two upper and two lower rails might be used.

FIG. 17 is a front isometric view of a sawhorse 120 in accordance with another non-limiting embodiment of the disclosed concept. The sawhorse 120 includes a body 122, and first and second pairs of legs 140a,140b pivotally connected to the body 122. The body 122 preferably comprises first and second end supports 128, a central support 134 located between the first and second end supports 128, and a plurality of rails 126a-d,136a-d. In one example, the central support 134 and the first and second end supports 128 are similar in structure/configuration. In the example of FIG. 17, the plurality of rails 126a-d,136a-d includes a first plurality of rails 126a-d extending between the first end support 128 and the central support 134, and a second plurality of rails 136a-d extending between the second end support 128 and the central support 134.

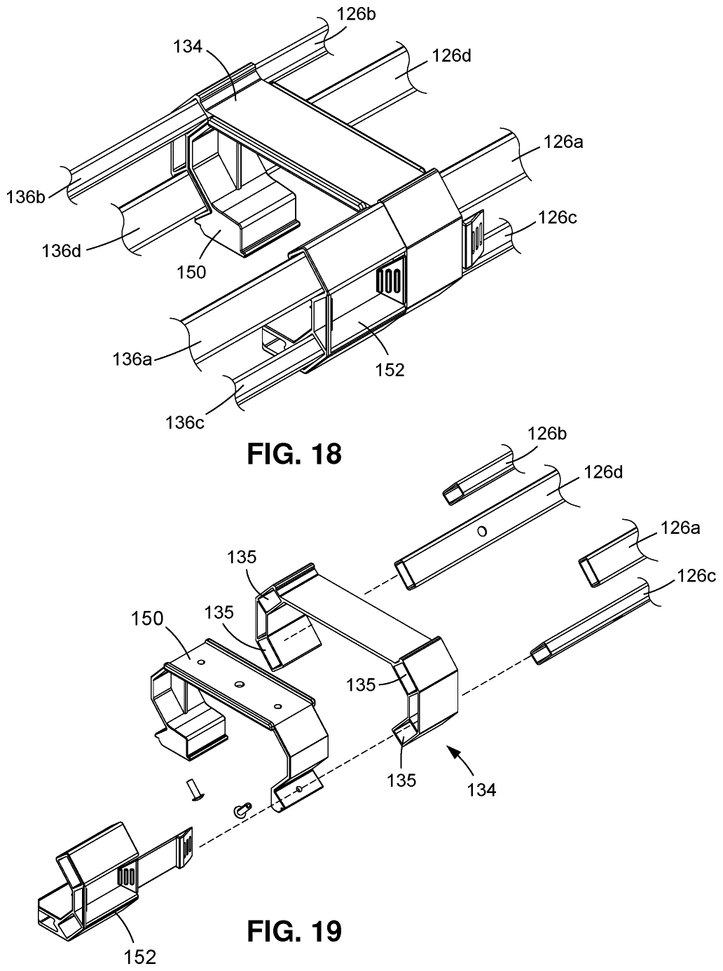

FIG. 18 shows an enlarged view of the central support of FIG. 17, and FIG. 19 shows an exploded view of a portion of FIG. 18. As shown in FIG. 19, the central support 134 has a plurality of openings 135 for receiving first ends of the first plurality of rails 126a-d. The openings 135 are also configured to receive first ends of the second plurality of rails 136a-d (not shown in FIG. 19, but see FIGS. 17 and 18). The opposing second ends of the first plurality of rails 126a-d and second plurality of rails 136a-d are preferably detachably coupled to the first and second end supports 128. Accordingly, it will be appreciated that each of the first plurality of rails 126a-d and the second plurality of rails 136a-d are detachably coupled to the central support 134 and a corresponding one of the first and second end supports 128. In this manner, the sawhorse 120 may be shipped or stored/stowed with a reduced size, in that one or both of the pairs of rails 126a-d,136a-d may be detached from the central support 134 (and the end supports 128) so that the sawhorse 120 has a length which is half of the total length of the sawhorse when assembled (in one embodiment, the legs of the pairs of legs 140a,b are no longer than the rails). Of course, this principle might be applied to a sawhorse 120 with more than one central support 134, such as where the sawhorse 120 is effectively divided into 3 or 4 sections, thus reducing the total length of the rails of each section and thus allowing the sawhorse 120 to be broken down into components having a length which is much shorter than the assembled length of the sawhorse 120).

Once again, the sawhorse 120 may include a fixed leg lock 150 and one or more sliding locks 152 (similar to the fixed lock 50 and sliding lock 52 described above), where the fixed lock 150 may be connected to the central support 134 and then the sliding lock 152 may be slidable mounted along one or more of the rails and be configured to selectively engage the central support 134, such as for selectively engaging the legs to retain them in their stowed position).

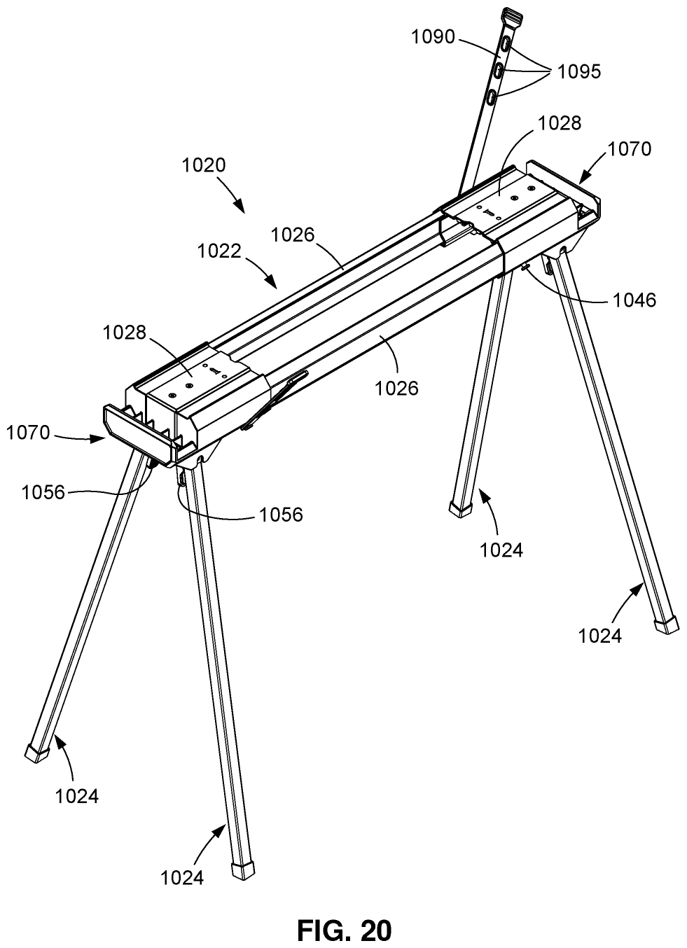

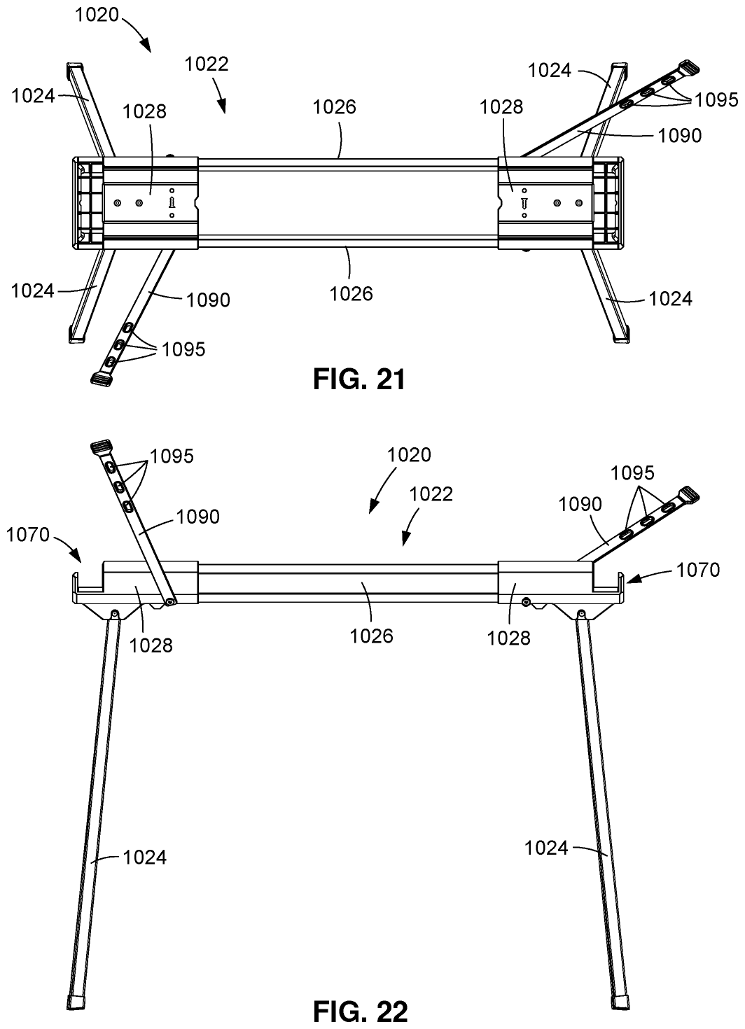

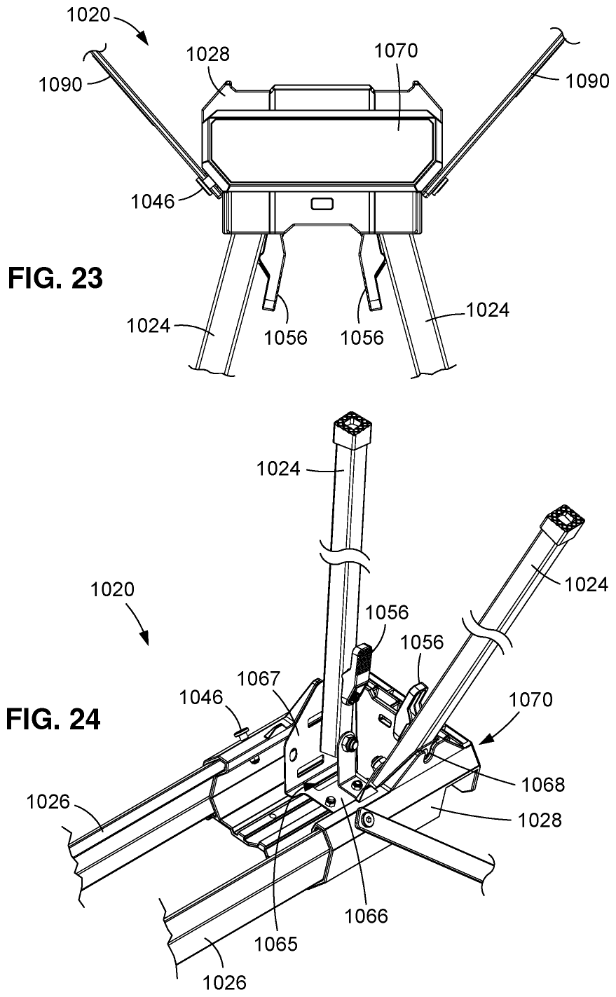

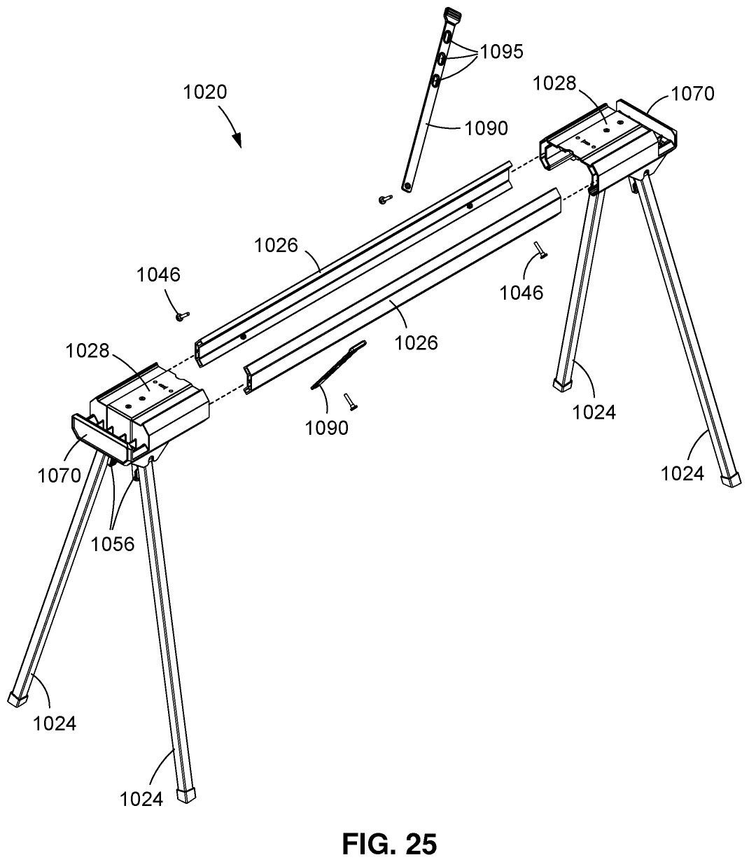

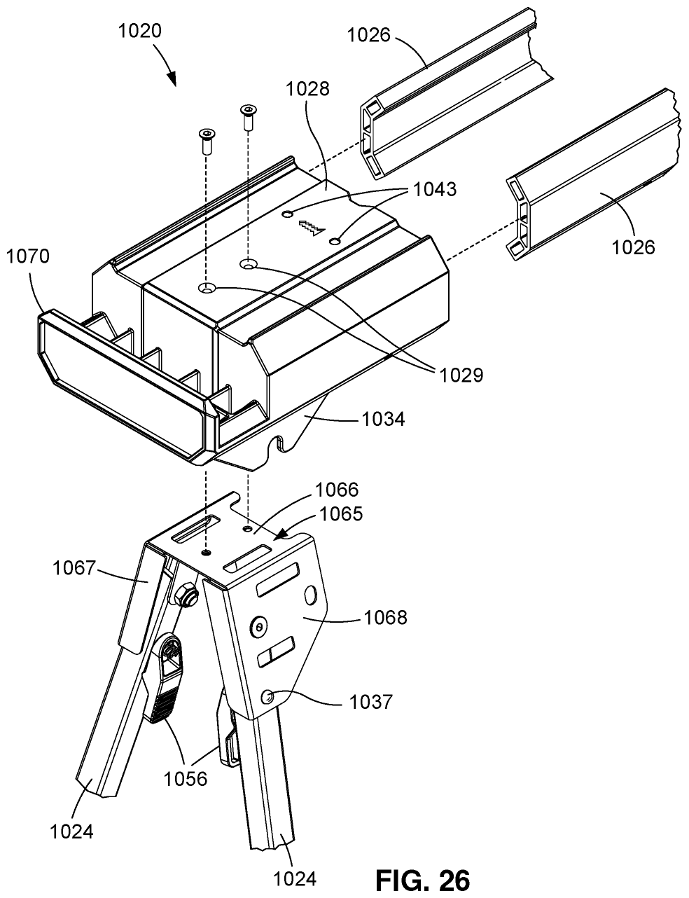

Another embodiment of the invention will be described with reference to FIGS. 20-30. In one embodiment, as shown in FIG. 20, a sawhorse 1020 includes a body 1022 and one or more legs 1024. The sawhorse 1020 may be similar to the sawhorse 20, discussed above, wherein like numbers have thus ben utilized to designate like features thereof. The body 1022 may have a plurality of rails 1026 which extend between end supports 1028. In a preferred embodiment, however, the rails 1026 may be extruded (or molded) PVC/ABS (or other durable monomeric and/or polymeric plastic material) body beams. In this embodiment, there are two side rails 1026, although in other embodiments, other numbers of rails (such as 4 or 8) might be utilized.

The legs 1024 may be fold-out legs, in one example embodiment. Once again, two legs 1024 may be provided at each end of the sawhorse 1020. The legs 1024 may be movable between a first folded position, such as where they extend generally parallel to the body 1022, and a second extended position, such as where they extend outwardly generally perpendicular to the body 1022, such as illustrated in FIG. 22. One or more locking or latching mechanisms or members may be provided for retaining the legs 1024 in their first and/or second positions. The legs 1024 may also be constructed from monomeric and/or polymeric materials, e.g., molded or extruded plastic.

The end supports 1028 may, as best illustrated in FIG. 30, comprise generally C-shaped bodies. Additionally, in one embodiment, an end cap 1070 may be located at each end of the body 1022. The end caps 1070 may extend outwardly from the end supports 1028 in a direction opposite the rails 1026. In one embodiment, the end caps 1070 and the end supports 1028 are formed as unitary components made from single pieces of material, such as, for example, monomeric materials, polymeric materials, and mixtures thereof (e.g., without limitation, injection molded plastics). This simplifies assembly and reduces the cost of the sawhorse 1020. In a configuration in which the end caps 1070 are spaced from a corresponding portion of their associated end supports 1028, a workpiece support may be defined therebetween. This workpiece support may comprise, for example, a channel for accepting a workpiece (piece of lumber, portion of pipe, or the like).

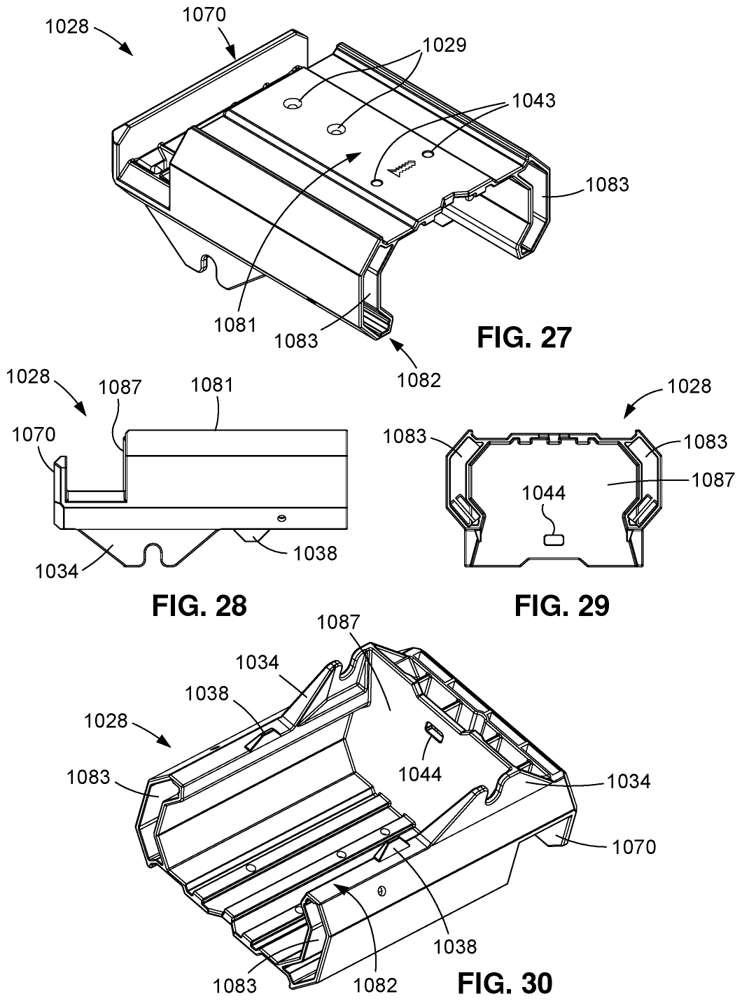

Referring to FIGS. 27-30, it will be appreciated that the relatively tough plastic end support 1028 prevents the sawhorse 1020 from damaging other objects and also prevents damage to the sawhorse, such as during shipment. For example, wood sawhorses that utilize metal end pieces may damage objects, such as if the sawhorse falls over or is dropped. Likewise, existing sawhorses may be damaged in a similar manner or during shipment. For example, the metal end pieces (such as which often define leg hinges) may bend or deform and no longer be operable and/or wood pieces may break. The use of monomeric and/or polymeric, e.g., plastic, end caps in accordance with the invention results in high durability against breakage or deformation, such as may be encountered during shipment and use. As indicated below, in one embodiment, the plastic end caps 1028 may extend over and thus protect metal leg brackets—which while providing durability and strength to the legs, protects those brackets both from damage and from damaging other objects.

Continuing to refer to FIGS. 27-30, in one embodiment, the end supports 1028 preferably define a top side 1081, a rear or bottom side 1082, and a pair of receiving portions 1083 each extending between the top side 1081 and the rear or bottom side 1082. Each of the pair of receiving portions 1083 is configured to receive and be coupled to at least one of the plurality of rails 1026 (FIG. 20). The top side 1081 is preferably configured to provide a stable work surface, such as when clamps or similar elements are used with the sawhorse 1020. For example, the top side 1081 may be relatively flat and allow clamps to square against the body of the end support 1028, as opposed to prior art sawhorses which have rounded body elements.

Moreover, the end supports 1028, as shown in FIGS. 27-30, further have a back side or end 1087 extending between the top and rear sides 1081 and 1082, and optionally include the end caps 1070 extend outwardly from the back side 1087 away from the receiving portions 1083. In one example, the end cap 1070 defines a slot between a distal portion thereof and the back side 1087, for receiving a workpiece therein.

The sawhorse 1020 may include one or more mounting or hanging points, such as for storing the sawhorse 1020 (particularly with the legs folded) when not in use. For example, one or more openings or apertures (or recesses/slots) 1044 may be provided in the end support 1028, such as for accepting a fastener head, hook or the like. As illustrated in FIG. 29, for example, an opening 1044 might be provided in the back or end 1087 of the end support 1028 (preferably centrally in the width direction so that the sawhorse 1020 hangs directly vertically) for this purpose.

In one embodiment, the sawhorse 1020 may include a means for connecting one or more elements (such as a workpiece, another sawhorse 1020, etc.) thereto. The means for connecting may comprise, as shown in FIGS. 20-25, at least one elongate strap 1090. The strap 1090 may have a first end which is coupled to one side of the end support 1028 and a second or free end which may be selectively connected to a member (e.g., without limitation, a pin 1046 having an enlarged head) provided with or coupled to an opposing side of the end support 1028. In one embodiment, the strap 1090 may include a plurality of spaced apertures 1095 (FIGS. 20-25) for accepting the pin 1046 in a corresponding plurality of different positions. In another example, the pin 1046 may be a protruding portion formed integrally with the end support instead of being a separately coupled element. The strap 1090 may be used to strap down a workpiece to the sawhorse 1020. Additionally, the strap 1090 may be employed to stack two sawhorses 1020 together for easy transport or wall storage (such as by extending the straps of one sawhorse 1020 around another sawhorse 1020 which is located on top thereof). Moreover, in one example the pin 1046, or other suitable member, is provided with or coupled to a first one of the receiving portions 1083 of the end support 1028, and the strap 1090 is coupled to a second, opposite one of the receiving portions 1083.

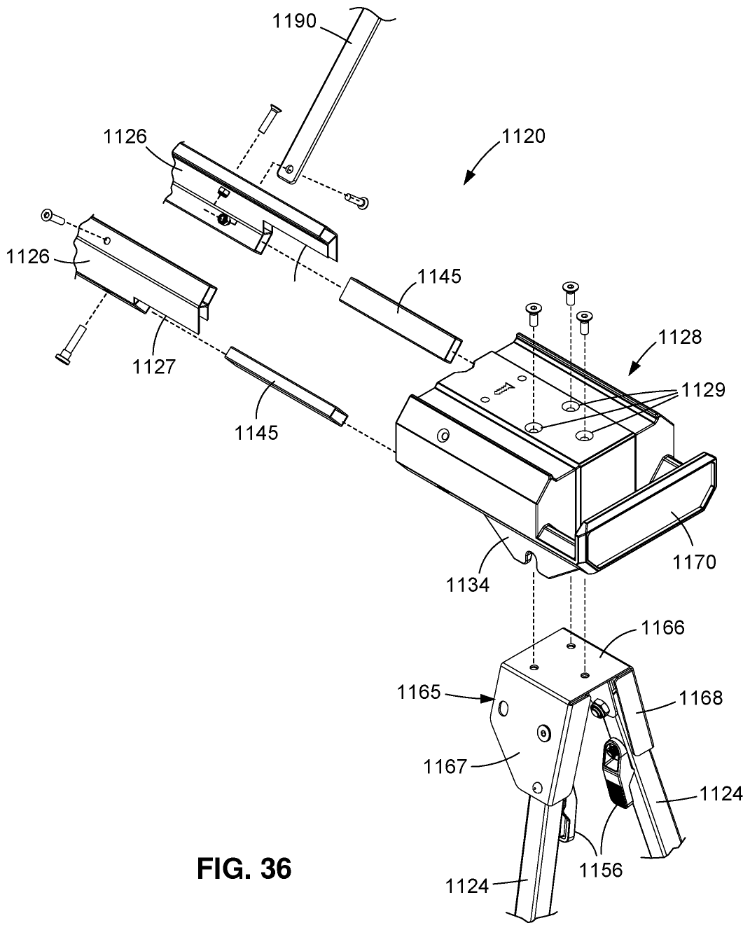

In one embodiment, each pair of legs 1024 is movably (e.g., rotatably) connected to a leg bracket 1065, such as illustrated in FIG. 24. The leg bracket 1065 may be generally “U” shaped, having a base portion 1066 and first and second legs 1067 and 1068 extending from the base portion 1066. See also, for example, leg bracket 1165 shown in FIG. 36, which similarly includes a base portion 1166 and first and second outwardly extending legs 1167 and 1168. In one example, one of the legs 1024 is rotatably coupled (such as about the shank of a bolt) to each of the legs 1067 and 1068 of the leg bracket 1065.

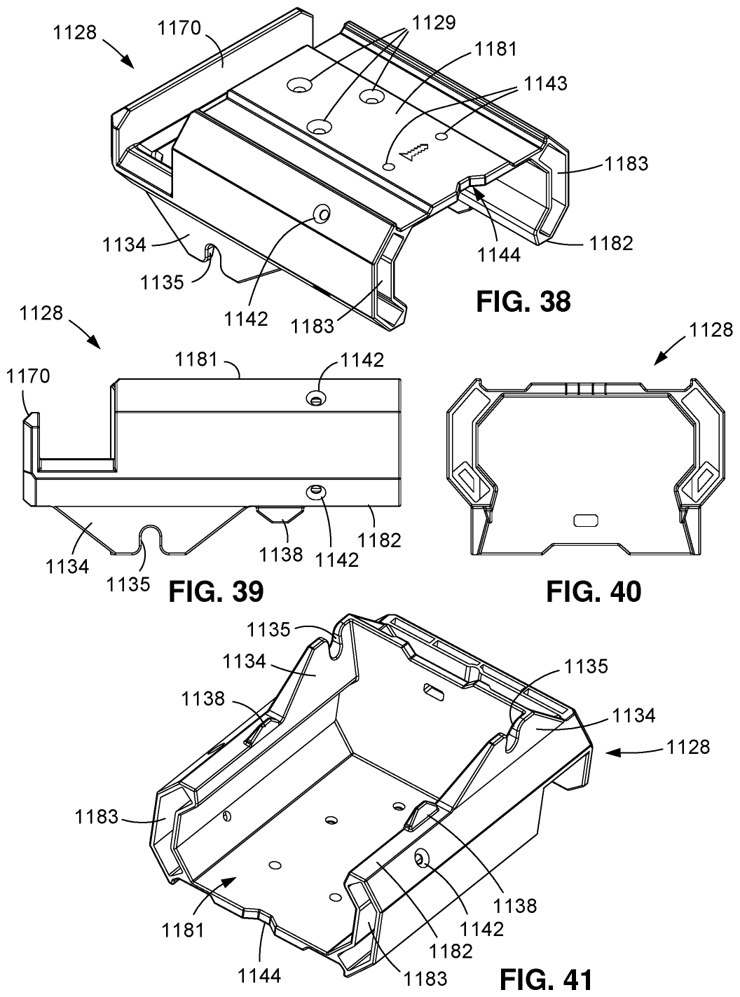

Continuing to refer to FIG. 24, the leg bracket 1065 may be constructed from metal and may be located in a cavity which is defined at the bottom of the end support 1028. Referring to FIGS. 27-30, apertures or holes 1029 in the end supports 1028 allow the leg bracket 1065 to be mounted to the end caps 1028. In the example shown, each end cap 1028 may have two pairs of thru holes 1029 and 1043. However, it will be appreciated that a suitable alternative end support 1028 (e.g., end support 1128 in FIGS. 38-41) may have an alternative number of holes (e.g., without limitation, three thru holes 1129 and two thru holes 1143), without departing from the scope of the disclosed concept. Fasteners (threaded fasteners, rivets, etc.) may be passed through these holes 1029 and 1043 and into engagement with the base portion 1066 of the leg bracket 1065 to secure the leg bracket 1065 to the end support 1028.

As shown in FIGS. 20-26, each pair of legs 1024 may be rotatably coupled to one of the leg brackets 1065. In one embodiment, a leg 1024 is rotatably mounted to each leg 1067 and 1068 of the leg bracket 1065, such as with a faster or by other mounting. Further, a means may be provided for selectively locking or retaining the legs 1024 into at least one position, such as the extended position. For example, the means may comprise a spring-loaded lever 1056 coupled to each of the legs 1024. See also, for example, spring-loaded lever 1156 in FIG. 35 of sawhorse 1120, which is similarly configured.

The lever 1056 may be pivotally mounted relative to the leg 1024. The lever 1056 may have a first end which may be engaged by a user and a second end which is associated with a pin or plunger 1037. The pin or plunger 1107, and the second end of the lever 1065, may be biased (such as with a spring) towards the leg 1024, and thus to a position in which the plunger 1037 engages with the sawhorse 1020, such as an opening in a corresponding side of the leg bracket 1065. The lever 1056 may be pivoted, such as about an outwardly extending foot which engages the leg 1024, by a user applying pressure to the first end of the lever 1056. This causes the second end of the lever 1056 to move away from the leg 1024, thus pulling the plunger 1037 rearwardly and thus out of engagement with the leg bracket 1065, such as to allow the leg to be folded to its first or folded/stowed position. In other words, movement of the levers 1056 disengages/engages a corresponding locking member which thus allows the corresponding legs 1024 to be moved between extended and stowed positions. Of course, the lever 1056 might be pivotally mounted in other manners, such as amount an axle or pin which is associated with the leg, etc. In another embodiment, the pin or plunger 1037 might have an enlarged head which the user can simply grip and pull rearwardly to pull the plunger 1037 rearwardly.

As shown in FIG. 30, the end support 1028 further has a number (e.g., two) of flanges 1034 extending outwardly from the rear or bottom side 1082, e.g., facing away from a location where tools may be coupled thereto. The flanges 1034 may be used to help support 2×4 (or other sized) support members that are placed in yokes that make tables, as well as aid in covering the leg brackets 1065 that help to lock the legs 1024 in place. Moreover, in one example, one of the pairs of legs 1024 is preferably located between the pair of opposing flanges 1034 of one of the end supports 1028 in a manner wherein one leg 1067 is located adjacent a first flange 1034, and a second leg 1068 is located adjacent a second flange 1034.

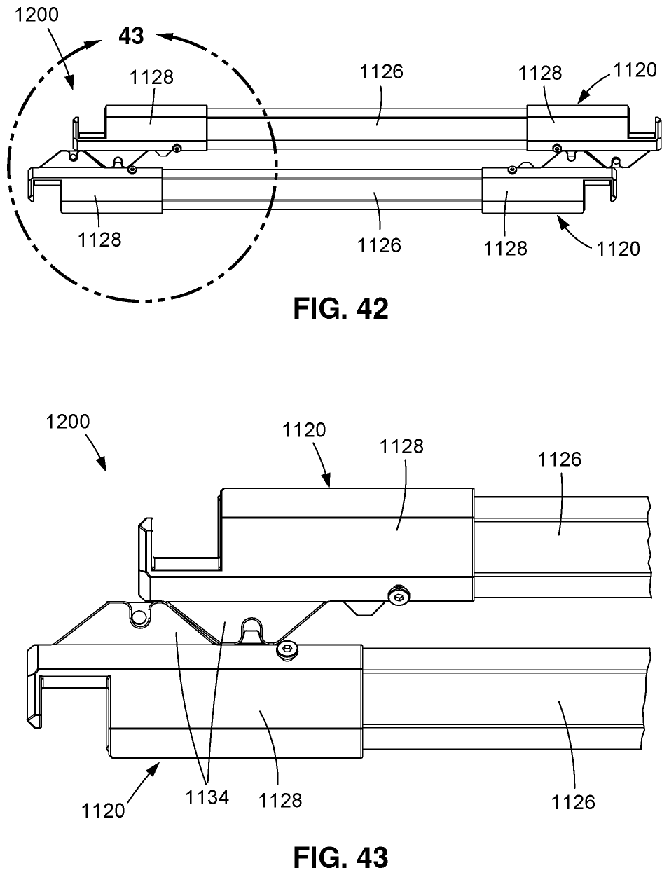

Located proximate the flanges 1034, and also extending outwardly from the rear side 1082 of the end supports 1028, are a number (e.g., without limitation, two) of protrusions (e.g., ears, tabs, or similar outwardly extending features) 1038 that facilitate stacking of the sawhorses 1020. When so stacked, the protrusions 1038 on one sawhorse 1020 extend upwardly and fit within the two sides of the leg bracket 1065 of the other sawhorse. This will also be discussed below in connection with FIGS. 42-44.

In this manner, when the sawhorses 1020 are stacked, they inter-engage, making it easier to transport and store them (where the two sawhorses do not slide side-to-side relative to one another because of the protrusions 1038 engaging the leg bracket 1065—it being recognized that the sawhorses 1020 are generally sold and used in pairs and so such stacking and transport and storage in such a stacked orientation, is highly desirable). Additionally, the end support 1028, like the metal (aluminum/steel) versions of the sawhorse desired herein (e.g., sawhorse 20 described above), includes the receiving portions 1083 to allow the rails 1026 of the sawhorse 1020 to be inserted into the end supports 1028.

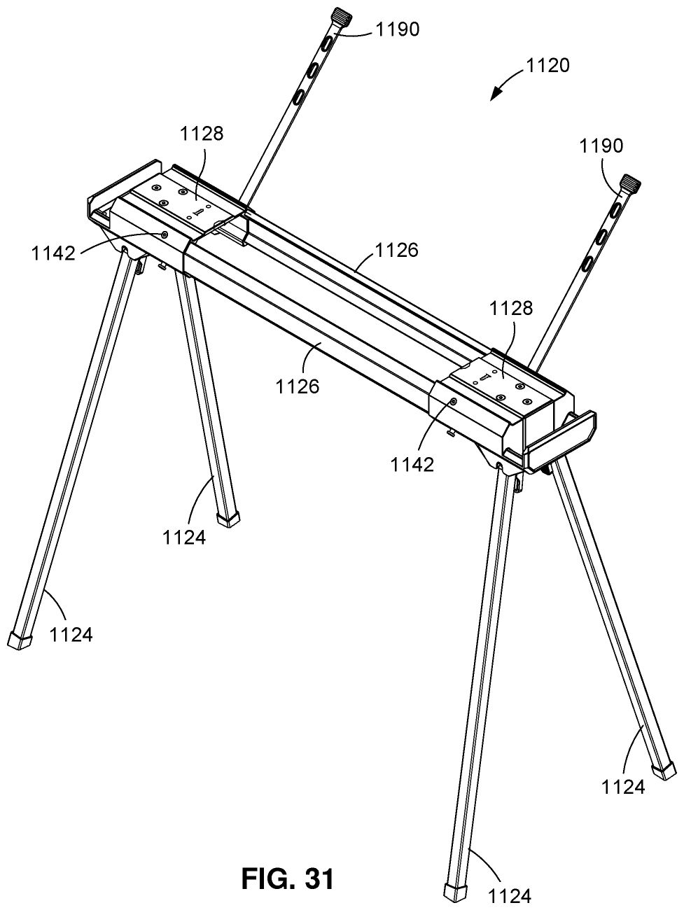

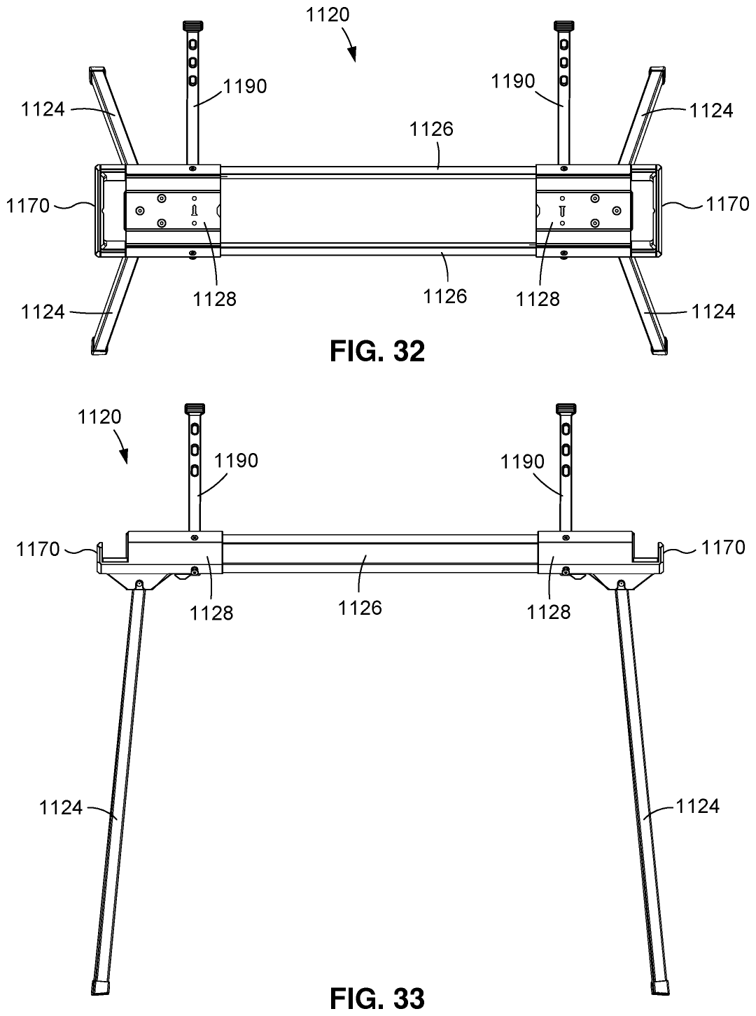

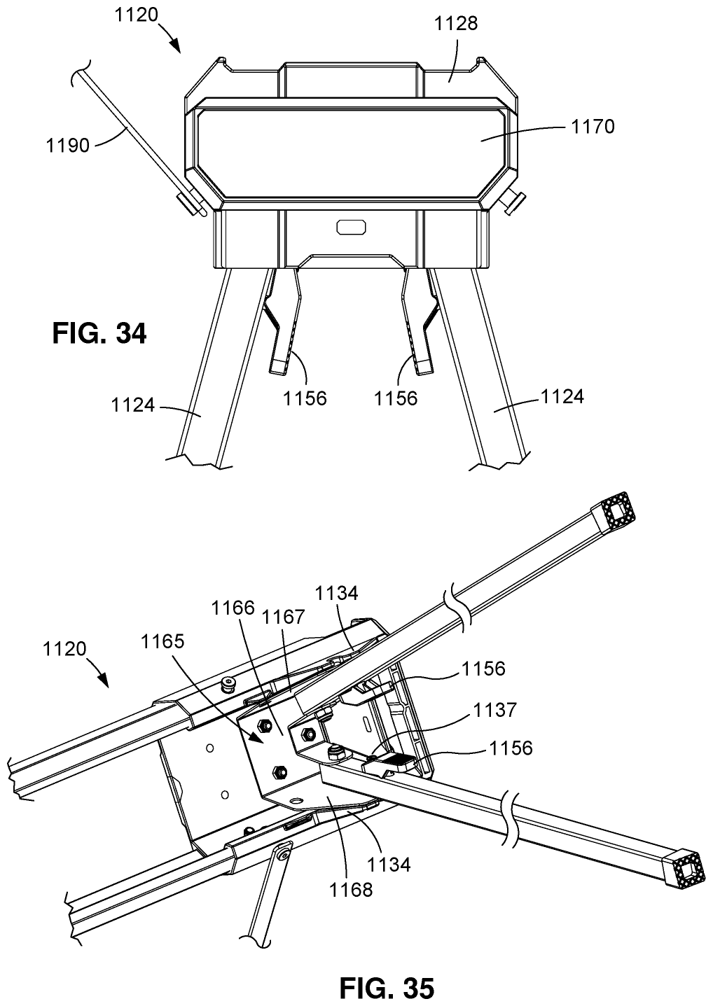

FIGS. 31-42 are views of another sawhorse 1120 and/or components thereof, configured like the sawhorse 1020, discussed above, wherein like numbers have been used to designate like elements. Accordingly, the sawhorse 1120 includes opposing and spaced apart pairs of legs 1124, opposing and spaced apart pairs of rails 1126 extending between the legs 1124, and a pair of end supports 1128 each coupled to a corresponding one of the pairs of legs 24, and each receiving the rails 1126 in the same manner in which the end supports 1028 (FIG. 20) receive the rails 1026. Furthermore, in one example these components 1124 and 1126 and 1128 may be made of monomeric and/or polymeric materials. In this embodiment, the sawhorse 1120 might only include two rails 1126, e.g. one at each side of the body. As indicated, these rails 1126 might be extruded, and might have a number of configurations. For example, the rails 1126 might be generally “C”-shaped in cross-section, and may define one or more flanges, slots or other elements, such as for receiving or connecting elements thereto.

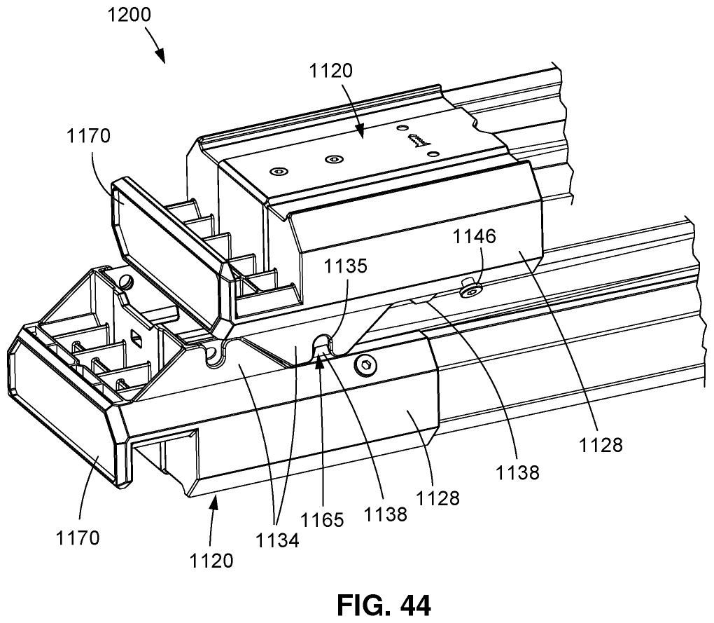

The sawhorse 1120 may again include one or more straps 1190 for selectively connecting one or more objects (such as workpieces) thereto, and for use in connecting two or more sawhorses in a stacked configuration, such as for storage and transport. The straps 1190 may again be selectively connectable to a pin 1146 (see FIG. 44).

As shown in FIGS. 38, 39, and 41, the end support 1128 may have a number of holes 1142 that pass through the side of the body in order to allow a coupling member (e.g., a screw or other fastener) to be placed therethrough to connect the end support 1128 to the rails 1126. Although two sets of holes 1142 are shown on each side, the holes might be reduced to a single set, or eliminated altogether (where the elements may be connected via adhesive (e.g., glue or epoxy). Additionally, there are a number (e.g., two) of holes 1129 and 1143 in the end support 1128 that allow a screw or other fastener to be passed through. This may allow for a sacrificial 2×4 or other member to be semi-permanently mounted to the top of the sawhorse 1120, as opposed to using the straps 1190.

Referring to FIGS. 35 and 41, the flanges 1134 may have a notch 1135 (see FIG. 41) in the body thereof which allows a pin or plunger 1137 (FIG. 35) to extend through each of the first and second legs 1167 and 1168 and the leg bracket 1165, but also allowing it to be visible—such as to allow the user to visually confirm that the legs 1124 are in a locked and open position.

As indicated above, the sawhorse may be provided with one or more mounting elements or points, such as one or more openings, slots or the like (such as opening 1044 described above relative to the sawhorse 1020). This embodiment sawhorse 1120 may include the same opening. In addition, as illustrated in FIG. 41, another example of such a mount or support comprises a centrally located notch 1144 in an end portion of the plastic end supports 1128 that allows the unit to be hung on a wall (such as by being placed on a screw, bolt or other element extending outwardly therefrom) with a balanced center of gravity (and allows hanging of the sawhorses 1120 even when they are stacked (such as strapped together as described below).

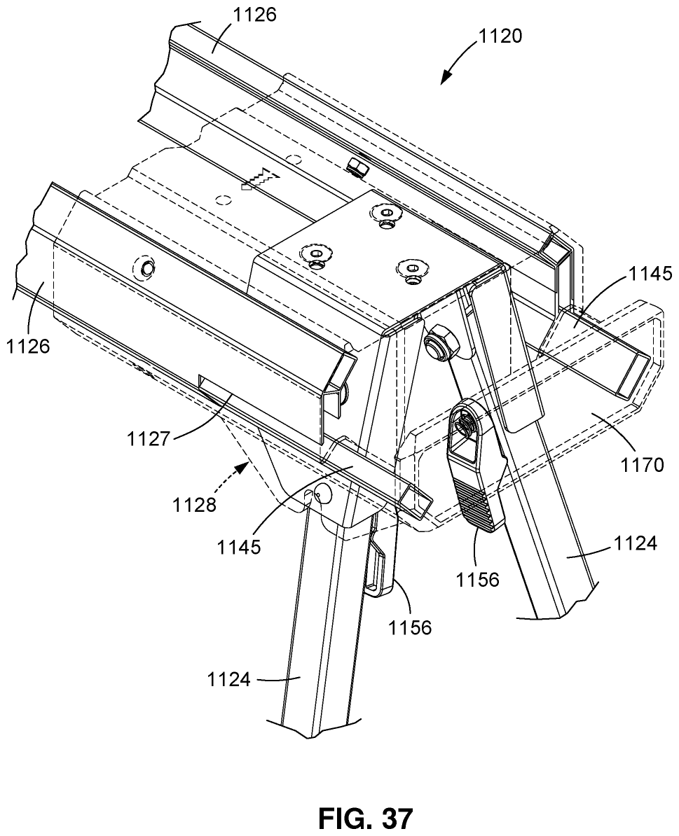

Referring again to FIGS. 36 and 37, in one example at least one of the rails 1126 includes an L-shaped cutout region 1127 located at an end thereof. Furthermore, the example sawhorse 1120 may include at least one corresponding elongated component 1145, which may be a metallic (e.g., steel) tube or other member. In one example, the elongated component 1145 is loosely maintained in a cavity defined by the receiving portion 1183 via engagement with the L-shaped cutout region 1127. In other words, the elongated component 1145 fits within the cutout region 1127 such that a portion of the rail 1126 is disposed and/or engaged with two sides (e.g., perpendicularly oriented sides) of the elongated component 1145. In this manner, the end caps 1170 may be spaced or cantilevered outwardly from the end supports 1128. These elongated components 1145, as shown in FIG. 37, extend from the end support 1128 outwardly to the end cap 1170, thus acting as a cantilevered support for the end cap 1170 and any workpiece which is located in the workpiece opening or slot between the end cap 1170 and the end support 1128. The elongated component 1145 may also be replaced with a bolt or other reinforced body that would help to strengthen the assembly in order to meet the desired capacity.

Referring to FIGS. 41-44, the sawhorse 1120 (e.g., and also the sawhorse 1020, discussed above), is configured for stacking. As shown in FIG. 41, the end support 1128 includes a top side 1181, a rear or bottom side 1182 located opposite the top side 1181, a pair of opposing receiving portions 1183 each extending between the top side 1181 and the rear or bottom side 1182, and a pair of opposing and spaced apart protrusions 1138 each extending outwardly from the rear side 1182 and being configured to nest between opposing legs 1167 and 1168 of a leg bracket 1165 of another sawhorse 1120. Additionally, in one example the receiving portions 1183 are configured to receive and be coupled to at least one of the rails 1126.

In one example, the opposing protrusions 1138 are located in corresponding parallel and opposing planes with the receiving portions 1183 (e.g., one protrusion 1138 on one side of the end support 1128 is located, or substantially located, in a plane with one receiving portion 1183 on the same side of the end support 1128). Moreover, it will be appreciated that each of the two depicted flanges 1134 are likewise configured to be located in the opposing parallel planes. Additionally, the geometry of the flanges 1134 is configured for stacking. More specifically, the flanges 1134 each include first and second edges that extend outwardly from the rear side 1182 toward one another so that the each of the flanges 1134 can engage with corresponding parallel edges of flanges of an end support of another sawhorse 1120. See FIGS. 42-44, for example and without limitation.

In one embodiment, the sawhorses 1120 may be stacked as illustrated in FIGS. 42-44, which show an example stacking or packing configuration (or when shipped and stored as a used, a pair of sawhorses 1120 forming a kit 1200) comprising two of the sawhorses 1120. As illustrated, the sawhorses 1120 are offset longitudinally by a distance which allows the flanges 1134 (on each side) of one sawhorse 1120 to be placed adjacent/in abutment to, the flanges 1134 of the other sawhorse 1120. The configuration of the end supports 1128 also facilitates compact and stable stacking of sawhorses 1120 on one another. Referring to the isometric view of the kit 1200 shown in FIG. 44, the protrusions 1138 of the bottom sawhorse 1120 fit within the sides of the leg bracket 1165 of the opposing (top) sawhorse 1120. This serves to prevent side-to-side movement of the sawhorses 1120 relative to one another, so that, in combination with the engagement of the flanges 1134, the sawhorses 1120 are linked in the side-to-side and longitudinal directions. Further, the straps 1190 of one or both of the sawhorses may be wrapped around the other one, thus preventing them from moving away from one another.

It will also be appreciated that the profile of the body of the sawhorse 1120 will work with a miter saw bracket as well. Having a body profile that can be used as a miter saw stand which uses extruded plastic materials is desirable. Moreover, a metallic (e.g., steel) bracket may be applied to a center of the assembly (e.g., between the rails 1126) that would minimize and/or prevent deflection under load. This would allow the overall body length to be increased, while maintaining the integrity of the unit.

It will be appreciated that the sawhorses 1020 and 1120 of FIGS. 20-44 may be referred to, and claimed as, a “plastic” sawhorse, due to the substantial portion thereof comprising plastic components. The components, e.g., the elongated rails 1026 and 1126, the legs 1024 and 1124, as well as the end supports 1028 and 1128 may each thus be understood to be made of monomeric and/or polymeric materials. This advantageously allows for a lower import duty tax. Additionally, as the sawhorses 1020 and 1120 are each preferably made of monomeric and/or polymeric materials, the sawhorses 1020 and 1120 may weigh less than 15 pounds, and in one example embodiment, weighs about 7 pounds—far lighter than traditional sawhorses. This allows the sawhorses 1020 and 1120 to be easily packed, shipped, and stored on shelves, for example. Additionally, sawhorses 1020 and 1120 may provide for a 50% reduction in shipping size versus a standard plastic sawhorse and even smaller when the sawhorses 1020 and 1120 are sent as a two-pack. At the same time, it will also be appreciated that the sawhorses 1020 and 1120 still have a high load capacity, such as up to 500 pounds of capacity or more.

One aspect of the invention is the simplistic construction of the sawhorses 1020 and 1120. For example, the rails 1026 and 1126 may be easily extruded and cut to length. The end supports 1028 and 1128 may be molded and may then be connected to the rails 1026 and 1126. The legs 1024 and 1124 may be formed, connected to the leg brackets 1065 and 1165 and then those leg brackets 1065 and 1165 with the associated legs 1067 and 1068 and 1167 and 1168, may be connected to the end supports 1028 and 1128. The simple construction of the sawhorses 1020 and 1120 reduces manufacturing time. Further, a user may easily replace elements of the sawhorses 1020 and 1120 if damaged or broken.

While particular configurations of sawhorses have been described herein, features of the sawhorses might be used in other combinations, including with other types of sawhorses. For example, while the sawhorse 20 is described as including pairs of legs that rotate together relative to the body of the sawhorse, while the legs of the sawhorses 1020 and 1120 rotate separately, the those configurations of legs might be interchanged. As another example, the legs of the sawhorse 20 might be configured as single element extruded members, rather than sliding/extending members.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

With regard to the methods described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

What is claimed is:

1. An end support for a sawhorse, the sawhorse comprising a body comprising a plurality of rails, a first pair of legs connected to said body, and a second pair of legs connected to said body, said end support comprising:
a top side;
a rear side;
a pair of receiving portions each extending between the top side and the rear side, each of the pair of receiving portions being configured to receive and be coupled to at least one of the plurality of rails; and
a pair of opposing and spaced apart protrusions each extending outwardly from the rear side and being configured to nest between opposing legs of a leg bracket of another sawhorse.

2. The end support according to claim 1, wherein the pair of receiving portions comprises a first receiving portion and a second receiving portion disposed opposite the first receiving portion, wherein the pair of protrusions comprises a first protrusion and a second protrusion disposed opposite the first protrusion, wherein the first receiving portion and the first protrusion are disposed in a first plane, and wherein the second receiving portion and the second protrusion are disposed in a second plane opposite and parallel to the first plane.

3. The end support according to claim 2, wherein the end support comprises a first flange and a second flange each extending outwardly from the rear side and each being disposed in a corresponding one of the first and second planes.

4. The end support according to claim 3, wherein the end support further comprises a back side extending between the top and rear sides, and an end cap extending outwardly from the back side away from the first and second receiving portions, and wherein the end cap defines a slot between a distal portion thereof and the back side, for receiving a workpiece therein.

5. The end support according to claim 4, wherein the back side has a centrally disposed thru hole or depression for allowing the end support to be hung on a wall with a balanced center of gravity.

6. The end support according to claim 3, wherein the top side has a plurality of thru holes for mounting of the end support to another leg bracket.

7. The end support according to claim 3, wherein the first flange comprises a first edge and a second edge each extending outwardly from the rear side toward one another so that the first flange can engage with a corresponding parallel edge of a flange of an end support of the another sawhorse, and wherein the second flange is shaped the same as the first flange.

8. The end support according to claim 3, wherein the end support is made of monomeric and/or polymeric materials.

9. A sawhorse comprising:
a body comprising a plurality of rails;
a first pair of legs connect to said body;
a second pair of legs connected to said body; and
an end support comprising:
a top side,
a rear side,
a pair of receiving portions each extending between the top side and the rear side, each of the pair of receiving portions receiving and being coupled to at least one of the plurality of rails, and
a pair of opposing and spaced apart protrusions each extending outwardly from the rear side and being configured to nest between opposing legs of a leg bracket of another sawhorse.

10. The sawhorse according to claim 9, wherein the end support comprises a first flange and a second flange each extending outwardly from the rear side and each being disposed adjacent a corresponding one of the pair of protrusions, and wherein the first pair of legs are each disposed between the first flange and the second flange.

11. The sawhorse according to claim 10, further comprising another leg bracket coupled to the top side, wherein the another leg bracket comprises a base portion, a first leg extending outwardly from the base portion, and a second, opposing leg extending outwardly from the base portion, wherein the first leg is disposed adjacent the first flange, wherein the second leg is disposed adjacent the second flange, and wherein the first and second legs are disposed between the first and second flanges.

12. The sawhorse according to claim 11, wherein the first pair of legs are rotatably coupled to the another leg bracket, wherein the first pair of legs comprises a first leg and a second leg, wherein the sawhorse further comprises a first spring-loaded lever and a second spring-loaded lever each coupled to a corresponding one of the first and second legs, wherein, responsive to movement of the first spring-loaded lever and the second spring-loaded lever causes the corresponding first and second legs to move between extended and stowed positions.

13. The sawhorse according to claim 9, wherein a first rail of the plurality of rails comprises an L-shaped cutout region disposed at an end thereof, and wherein the sawhorse further comprises an elongated component loosely maintained in a first receiving portion of the pair of receiving portions via engagement with the L-shaped cutout region.

14. The sawhorse according to claim 9, further comprising at least one strap coupled to the end cap and being configured to strap a workpiece to the sawhorse.

15. The sawhorse according to claim 14, further comprising a member either provided with or coupled to the end cap, wherein the at least one strap has a plurality of spaced apart apertures for accepting the member in a corresponding plurality of different positions.

16. The sawhorse according to claim 15, wherein the pair of receiving portions comprises a first receiving portion and a second receiving portion disposed opposite the first receiving portion, wherein the member is either provided with or coupled to the first receiving portion, and wherein the at least one strap is coupled to the second receiving portion.

17. A packaging kit comprising:
a first sawhorse comprising a first end support and a leg bracket coupled to the first end support, the leg bracket comprising a base portion, a first leg extending outwardly from the base portion, and a second, opposing leg extending outwardly from the base portion; and
a second sawhorse comprising a second end support, the second end support comprising a top side, a rear side, a pair of receiving portions, and a pair of opposing and spaced apart protrusions each extending outwardly from the rear side, the pair of protrusions comprising a first protrusion and a second protrusion disposed opposite the first protrusion,
wherein the first protrusion is disposed adjacent the first leg, wherein the second protrusion is disposed adjacent the second leg, and wherein the first and second protrusions are nested between the first and second legs of the leg bracket.

18. The packaging kit according to claim 17, wherein the first end support comprises a top side, a rear side, a pair of receiving portions, and a pair of opposing and spaced apart flanges each extending outwardly from the rear side of the first end support, the pair of flanges comprising a first flange and a second flange disposed opposite the first flange, and wherein the first and second protrusions of the second end support are nested between the first and second flanges of the first end support.

19. The packaging kit according to claim 18, wherein the first flange comprises a first edge extending outwardly from the rear side of the first end support, wherein the second end support comprises a third flange extending outwardly from the rear side of the second end support, wherein the third flange comprises a third edge extending outwardly from the rear side of the second end support, and wherein the first edge and the third edge engage and are disposed parallel to one another.

20. The packaging kit according to claim 18, wherein the first leg of the leg bracket is disposed between the first protrusion of the second end support and the first flange of the first end support, and wherein the second leg of the leg bracket is disposed between the second protrusion of the second end support and the second flange of the first end support.
